(19) United States
(12) Patent Application Publication
(10) Pub. No.: US 2016/0031696 A1
(43) Pub. Date: Feb. 4, 2016

(54) Dispensing container

(71) Applicant: EMS Mind Reader LLC, Newark, NJ (US)

(72) Inventor: Sol Michael Betesh, Brooklyn, NY (US)

(73) Assignee: EMS Mind Reader LLC, Newwark, NJ (US)

(21) Appl. No.: 14/121,108

(22) Filed: Jul. 31, 2014

(51) Int. Cl. B67D 3/00; B65D 47/30; B65D 47/20

(52) U.S. Cl. CPC B67D 3/0051; B65D 47/2006; B67D 3/0061; B65D 47/30

(57) ABSTRACT

A container for holding and dispensing substances which is enabled into a dispensing position by moving it and which can be enabled and used with one hand.

### BACKGROUND OF THE INVENTION

### Description of the Related Art

Containers for holding and then dispensing substances such as beverages and condiments can be classified into one of two categories: open or closed.

Open containers (e.g. cups, drinking glasses, pitchers, condiment containers and bins, etc.) are easy to use and dispense the contents of the container but do not provide insulation or protection of the contents from contamination and are easy to spill, often with very undesirable consequences. Closed containers can insulate and/or protect the contents and minimize or eliminate spills but require some separate manual action by the user to operate such as opening or removal of a lid, for example, to dispense the contents of the container.

Thus, there is a need in the art for a container that protects and/or insulates the contents, minimizes spills and which can be used as easily as an open container, namely which can be used to dispense or discharge the contents by simply moving (e.g. lifting) the container and can be used with one hand.

### SUMMARY OF THE INVENTION

A container for holding and/or discharging substance(s) comprising: one or more chambers for holding the substance(s); and means for enabling the substance in a chamber to be dispensed by moving the container.

The container as described above wherein the movement of the container to enable the substance to be dispensed is linear.

The container as described above wherein the movement of the container to enable the substance to be dispensed is lifting.

The container as described above wherein the container can be moved with one hand to enable the substance to be dispensed.

The container as described above wherein the means for dispensing the substance includes a grip coupled to the container.

The container as described above wherein the means for enabling a substance to be dispensed includes: a spout coupled to the container; a spout connector coupling a chamber to the spout; and wherein, when the container is moved, the spout connector engages the spout such that the substance held in such chamber can be dispensed through the spout connector and out of the spout.

The container of claim 1 wherein the means for enabling a substance to be dispensed includes: a passage way in the container through which the substance in a chamber can be dispensed; a movable stopper coupled to such passage way for closing and opening the passage way; an opening system coupled to the stopper, and wherein, when the container is moved, the opening system moves the stopper enabling the substance to be dispensed.

A container for holding and/or dispensing substance(s) comprising: an outer cavity; one or more inner chambers, disposed within the outer cavity, for holding the substance(s); and means for enabling the substance in an inner chamber to be dispensed out of the outer cavity by moving the container wherein such inner chamber moves with respect to the outer chamber and into a dispensing position.

The container as described above wherein the movement of the container to enable the substance to be dispensed is linear.

The container as described above wherein the movement of the container to enable the substance to be dispensed is lifting

The container as described above wherein the container can be moved with one hand to enable the substance to be dispensed.

The container as described above wherein the means for dispensing the substance includes: a grip coupled to an inner chamber and extending through the outer cavity wherein, when the grip is moved, such inner chamber moves with respect to the outer chamber into the dispensing position.

The container as described above wherein the outer cavity has one or more openings there through and wherein the grip includes: one or more ends extending through such openings and coupled to an inner chamber, and wherein the openings in the outer cavity are sufficiently large with respect to the grip ends to allow the grip to be moved such that the inner chamber and the outer cavity can be moved with respect to each other into the dispensing position.

The container as described above wherein the means for dispensing a substance includes: a spout coupled to the outer cavity; and a spout connector coupling an inner chamber to the spout; and wherein, when the container is moved, the spout connector engages the spout such that the substance held in the inner chamber can be dispensed through the spout connector and out of the spout.

The container as described above further including a lid, removably coupled to an inner chamber, for adding or removing a substance to such inner chamber.

A dispensing system for use in a container having a chamber for holding a substance, such dispensing system comprising: a spout coupled to the container; a spout connector coupling the chamber to the spout; and wherein, when the container is moved, the spout connector engages the spout such that the substance held in the chamber can be dispensed through the spout connector and out of the spout.

The dispensing system as described above wherein the movement of the container for the spout connector to engage the spout to enable the substance to be dispensed is linear.

The dispensing system as described above wherein the movement of the container for the spout connector to engage the spout to enable the substance to be dispensed is lifting.

The dispensing system as described above wherein the container can be moved with one hand for the spout connector to engage the spout to enable the substance to be dispensed.

The dispensing system as described above further comprising: a channel within the spout in which the end of the spout connector coupling the spout is movably disposed; and wherein, when the container is moved, such spout connector end moves within the channel to a dispensing position for the substance in the chamber.

### BRIEF DESCRIPTION OF THE DRAWINGS

FIG. 1A is a view of the container fully assembled.

FIG. 1B is a side view of the inner chamber.

FIG. 1C is a side view of the outer cavity.

FIG. 2A is a front view of the spout connector.

FIG. 2B is a side view of the spout connector.

FIG. 3A is a cross-sectional view of the spout and spout connector channel.

FIG. 3B is a cross-sectional view of the spout and spout connector channel and the spout connector in the normal position.

FIG. 3C is a cross-sectional view of the spout and spout connector channel and the spout connector in the dispensing position.

FIG. 4 depicts all of the components of the container to be assembled.

FIG. 5A depicts another embodiment of the container employing the present invention with the container in the normal or closed position.

FIG. 5B depicts the container of FIG. 5A in the dispensing position as the result of vertical movement of the container.

FIG. 5C depicts the container of FIG. 5A in the dispensing position as the result of horizontal movement of the container.

FIG. 5D depicts the container of FIG. 5A using the spout and spout connector of FIGS. 2 and 3, in the dispensing position by non-vertical movement of the container.

### DETAILED DESCRIPTION

Whilst the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention and do not limit the scope of the invention. Moreover, the present invention, while described for the dispensing of beverages and condiments is not limited thereby and may be used for dispensing a wide variety of liquids and solids.

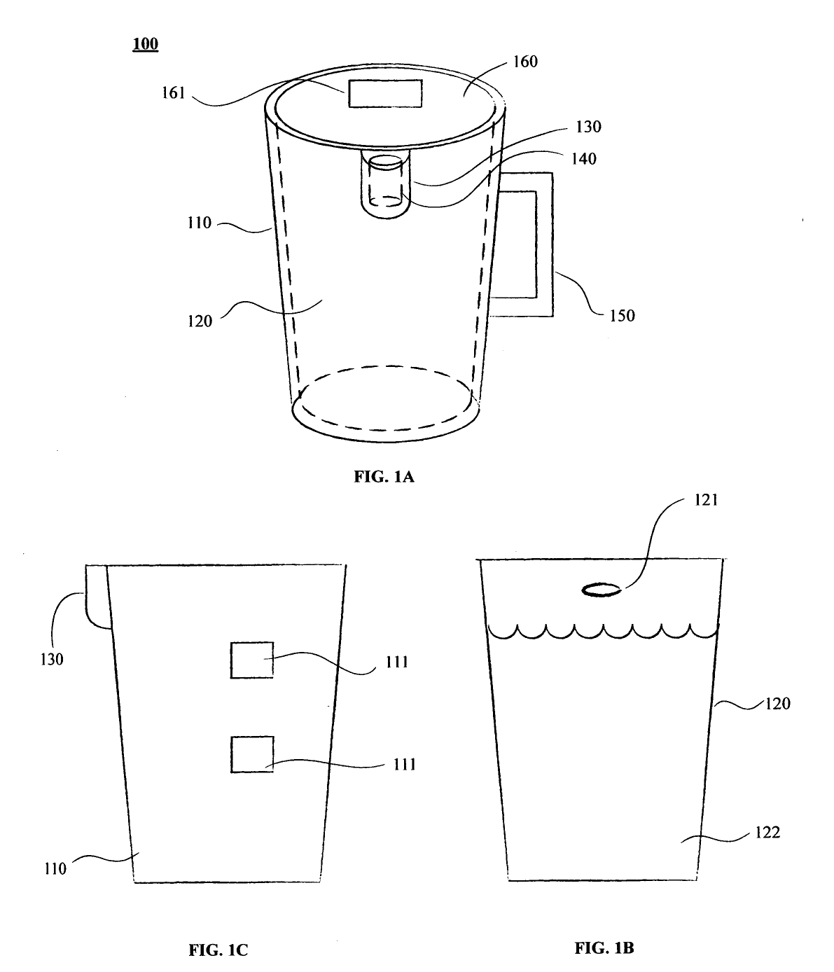

Referring now to FIG. 1A, a view of a container 100 fully assembled and employing the present invention is depicted. The container 100 is comprised of an outer cavity 110; an inner chamber 120 for holding a substance to be dispensed and disposed within the outer cavity 110; a spout 130 disposed within outer the cavity 110; and a spout connector 140 coupled to the spout 130 and the inner chamber 120 for passage of the substance in the inner chamber 120 out of the container 100 via the spout 130 when the container is in a dispensing position.

The container 100 in FIG. 1A is also depicted with a grip 150, coupled to the inner chamber (not shown) by any suitable method for moving the container and a lid 160 with a tab 161 for operating the lid 160. The lid 160 is detachably secured to the inner chamber 120 by any suitable method and allows substances to be added to or removed from the inner chamber 120; closing and/or sealing the inner chamber to protect the substance therein from contamination, insulating the substance within the inner chamber 120, preventing undesirable spills of the substance held in the inner chamber 120 and for cleaning. It will be appreciated that the lid 160 may be made of any suitable material such as plastic, for example, and constructed in a variety of ways to detachably couple it to and from the inner chamber 120. For example, the outer perimeter of the lid 160 may be threaded to mate with a compatible threading of inner perimeter of the inner chamber 120 and operated by means of the tab 161 or other suitable device. It will be further appreciated that the tab 161 is merely one example of a device to operate the lid 160.

Referring now to FIG. 1B, the inner chamber 120 holds the substance 122 for dispensing and may be made from any suitable material, such as plastic, for example. The inner chamber 120 for the container 100 in FIG. 1A is sized to slidably fit within the outer cavity 110. The inner cavity 120 is also configured with a means 121 for coupling with the spout connector 140. FIG. 1B depicts this means 121, for example, as an opening through the inner chamber 120 sized to form a sealed coupling with the spout connector 140 when the spout connector 140 is inserted into the opening 121. It will be appreciated that a variety of methods and apparatus can also be employed to achieve the coupling of the spout connector 140 with the inner chamber 120.

Referring now to FIG. 1C, a side view of the outer cavity 110 is depicted. The spout 130 is also depicted from the side and will be further described hereinafter. Not depicted in this FIG. 1C, but to be described hereinafter, is an end of the spout connector 140 movably disposed in the spout 130.

The outer cavity 110 is depicted with two openings 111 which allow the ends of the grip 150 to pass through the outer cavity and be attached to the inner chamber by any suitable means. The openings are disposed and are large enough for the ends of the grip 150 to rest there on when the container 100 is in a normal or (substance) holding position, and to allow the grip 150 ends to move upward when the grip 150 is lifted, thereby moving the inner chamber 120 with respect to the outer cavity 110 and moving the spout connector 140 to the dispensing position within the spout 130.

Accordingly, when the grip 150 is lifted and thereby moving the container 100, the inner chamber 120 moves upwardly with respect to the outer cavity 110 until the spout connector is in the dispensing position within the spout 130.

The grip 150 is depicted as a handle in FIG. 1A but, it will be appreciated that a variety of other suitable mechanisms can be employed to move the container 100 so that it is in the dispensing position. It will be further appreciated that the container 100 can be moved such that it is in the dispensing position by moving the outer cavity 110.

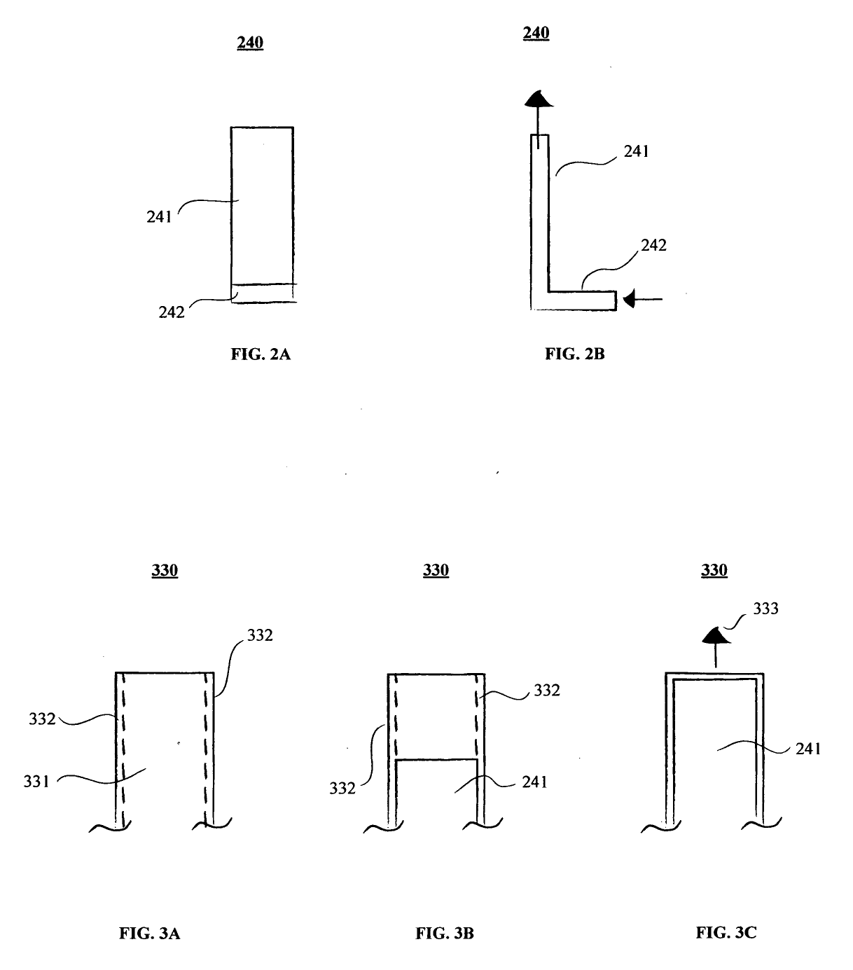

Referring now to FIGS. 2A and 2B, the spout connector 240 is depicted from a front view and a side view, respectively. In FIG. 2B, directional flow arrows are depicted showing the flow of the substance from the inner chamber 120, through the spout connector 240 and out of container 100 via the spout 130. The end of the spout connector 241 is slidably disposed in the spout 130 while the end of the spout connector 242 is coupled and secured to the opening 121 of the inner chamber 120.

The spout connector 240 may be formed from any suitable material, such as, for example, semi-flexible tubing. It will be appreciated that a variety of other means may be implemented to achieve the functionality of the spout connector 240. For example, the inner chamber 120 could be fabricated to include a spout connector 240.

Referring now to FIG. 3A, a cross-sectional view of the spout 330 is depicted without the end of the spout connector 241 disposed therein. The spout 330 has a channel 331 therein to allow the end of the spout connector 241 to slidably be disposed therein. The sides of the channel 332 are concave to act as channel guides for spout connector end 241 and retain the spout connector end 241 within the channel 331.

Referring now to FIG. 3B, a cross-sectional view of the spout 330 is depicted with the end of the spout connector 241 disposed therein in the normal or holding position. In this position, only portions of the channel guides 332 are visible.

Referring now to FIG. 3C, a cross-sectional view of the spout 330 is depicted with the end of the spout connector 241 disposed therein in the dispensing position. In this position, none of the channel guides 332 are visible. A directional flow arrow 333 is also depicted showing the flow of the substance from the inner chamber 120.

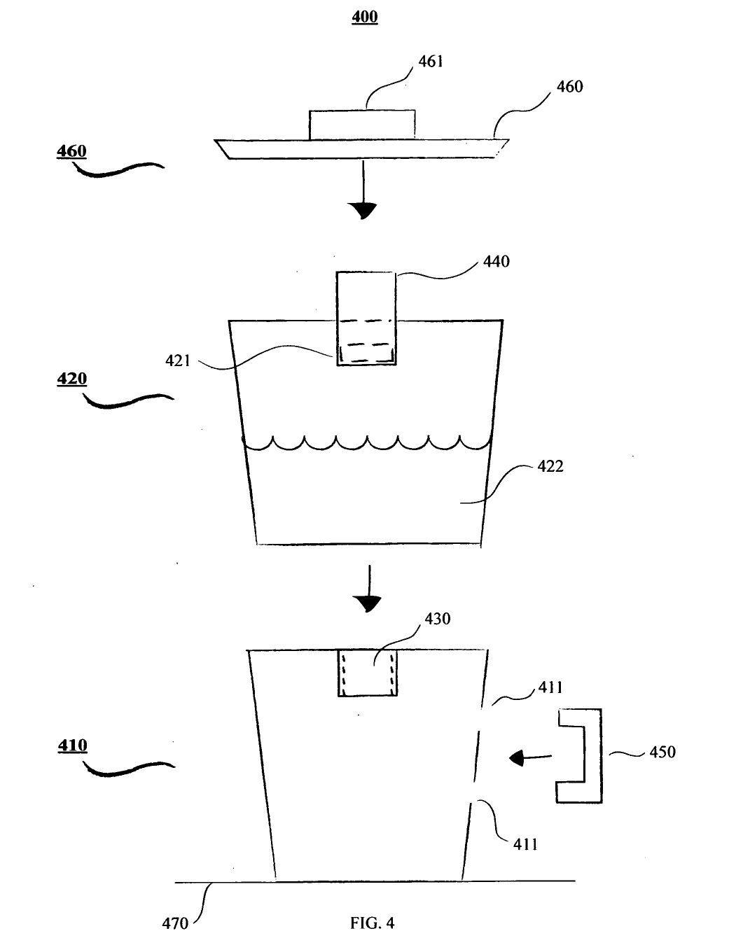

Referring now to FIG. 4, an assembly view of the container 400 is depicted. The lid 460 with tab 461 is depicted for attachment to the inner chamber 420; the inner chamber 420 is depicted as ready for insertion into the outer cavity 410 and with spout connector 440 having an end secured to the inner chamber opening 421 and a substance 422 therein; the outer cavity 410 with the spout 430; and the grip 450 depicted as ready for insertion through openings 441 in the outer cavity 410 for coupling to the inner chamber 420. It will be appreciated of course, that FIG. 4 is merely for illustration and is not meant to actually depict how the container 400 would be assembled.

A fully assembled container 400 situated on a surface 470 with a substance such as a beverage or a condiment in the inner chamber 420 and with the lid 460 secured to the inner chamber 420, is operated by a user merely by moving the container 400 with the grip such that the inner chamber 420 moves with respect to the cavity 410 and spout connector 440 is in the dispensing position. The container 400 is then oriented past vertical and the substance in the inner chamber 420 is dispensed. When the container 400 is moved back to the surface, the inner chamber 420 moves again with respect to the outer cavity 410 in the opposite direction and the container is returned to its normal or holding position.

Alternatively, the container 400 can be operated by moving the outer cavity 410 and rotating it past horizontal which results in movement of the inner chamber 420 with respect to the outer cavity 410 and the movement of the spout connector 440 to the dispensing position. In either alternative, the container 400 can be operated easily, with one hand, by moving the container 400 and without the need for any other action by the user.

It will be appreciated that a container employing the present invention, such as container 400, may also include mechanisms to lock or secure the container in the normal/holding position or in the dispensing position or both and a mechanism to close and open a spout connector, such as spout connector 420 when the container is in the normal/holding position and the dispensing position, respectively.

The container 400 has been depicted with a single inner chamber for holding a substance. It will be appreciated that the present invention also encompasses the use of more than one inner chambers 420 to accommodate more than one substance by use for example of a spout connector, such as spout connector 440 for each such inner chamber which can moved within its own spout in the container or pre-selected for coupling to a single spout container.

It will be further appreciated that the present invention can be embodied in a container without an outer cavity such as outer cavity 410. For example, by coupling a grip such as grip 450 through a wall of a chamber, such as inner chamber 420 wall and to a spout connector, such as spout connector 440, such that the grip when moved, moves the container and moves the spout connector 420 into a dispensing position within or through a spout such as spout 430, coupled to or incorporated in the chamber.

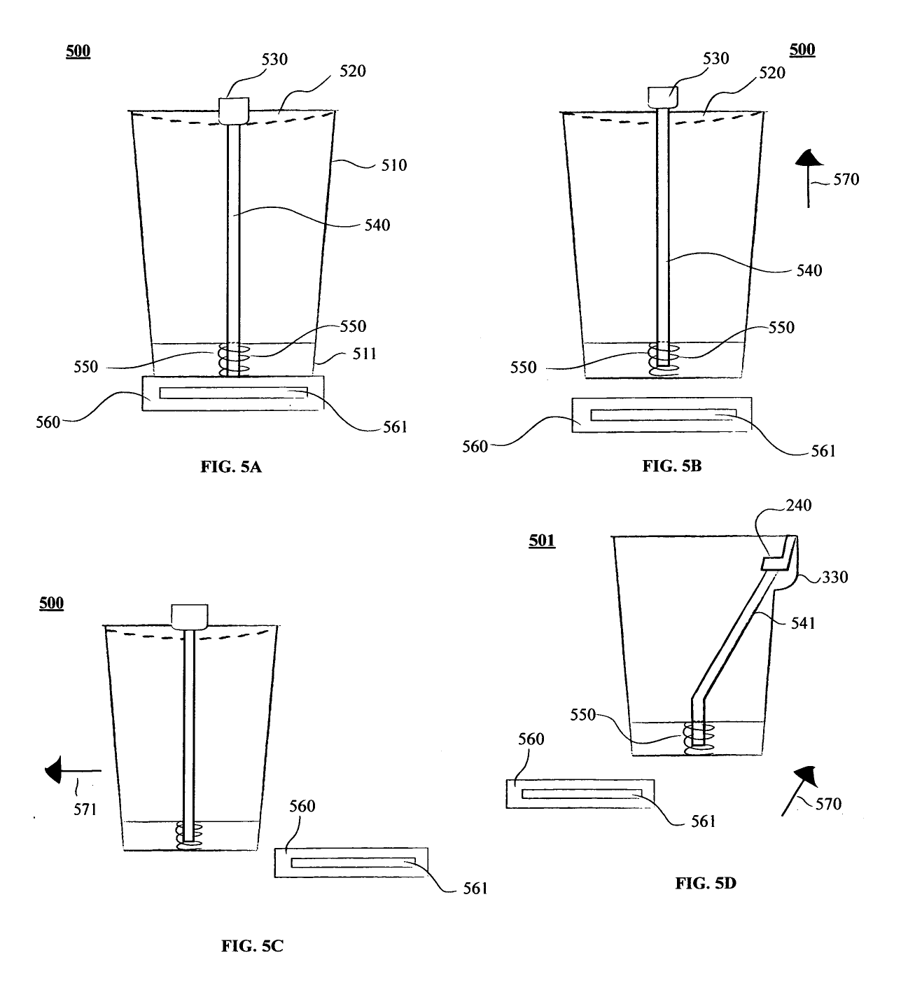

Referring now to FIG. 5A, another embodiment of the present invention is depicted. The container 500 includes a chamber 510 for holding a substance; a concave lid 520; a stopper or other suitable device 530 which can be moved into and out of an opening in the lid 520; a movable stem 540 coupled to the stopper 530 and extending through the chamber 510 and into a bottom section 511 of the chamber 510; and a spring 550 disposed in the bottom section 511 of the chamber 510 and coupled to end of the stem 540 disposed in the bottom section 511. The end of the stem 540 in the bottom section 511 is magnetized.

A base 560 with a magnet 561 is also depicted. When the container 500 is resting on the base 560 as shown in FIG. 5A, the magnet 561 attracts the stem 540 pulling the stem down; compressing the spring 550; and pulling the stopper 530 into the opening in the lid 520.

Referring now to FIG. 5B, the container 500 has been moved as shown by directional arrow 570. The magnet 561 in the base 560 is no longer able to pull the stem 540 down and the spring 550 has decompressed pushing the stem 540 upward and moving the stopper 530 out of the opening in the lid 520 enough to a dispensing position which allows the substance in the chamber 510 to be dispensed.

Referring now to FIG. 5C, the container 500 has moved as shown by directional arrow 571 with the same results as described in the preceding section.

Referring now to FIG. 5D, the container 501 has been altered to incorporate the spout 330 depicted in and described for FIGS. 3A through 3C and the spout connector 240 depicted in and described for FIGS. 2A and 2B. The stopper 530 is no longer needed and a simpler lid (not shown) can be used in place of lid 520. Also, the stem 541 has been altered to accommodate this embodiment of the invention. As shown in FIG. 5D, the container 501 has moved away from the base 560 with magnet 561 in the direction of directional arrow 571 and again with the results within the container 501 as previously except that that the stem 541 has moved the spout connector 240 into the dispensing position in the spout 330.

It will be appreciated that the embodiments of the present invention as depicted in FIGS. 5A through 5D with the use of a magnetized stem and a magnet can be achieved with a variety of other mechanical and electro-mechanical configurations to get the containers 500 and 501 into the dispensing position. It will also be appreciated that the embodiments of the invention in FIGS. 5A through 5D can be implemented with more than chamber in the container and still achieve the results of an easy to use, with one hand, closed container which can be moved in any direction to have the container in the dispensing position.

Thus, the present invention has been described herein with reference to particular embodiments for particular applications. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

What is claimed is:

1. A container for holding and/or dispensing substance(s) comprising:
one or more chambers for holding the substance(s); and
means for enabling the substance in a chamber to be dispensed by moving the container.

2. The container of claim 1 wherein the movement of the container to enable the substance to be dispensed is linear.

3. The container of claim 1 wherein the movement of the container to enable the substance to be dispensed is lifting.

4. The container of claim 1 wherein the container can be moved with one hand to enable the substance to be dispensed.

5. The container of claim 1 wherein the means for dispensing the substance includes a grip coupled to the container.

6. The container of claim 1 wherein the means for enabling a substance to be dispensed includes:
a spout coupled to the container;
a spout connector coupling a chamber to the spout; and
wherein, when the container is moved, the spout connector engages the spout such that the substance held in such chamber can be dispensed through the spout connector and out of the spout.

7. The container of claim 1 wherein the means for enabling a substance to be dispensed includes:
a passage way in the container through which the substance in a chamber can be dispensed;
a movable stopper coupled to such passage way for closing and opening the passage way;
an opening system coupled to the stopper; and
wherein, when the container is moved, the opening system moves the stopper enabling the substance to be dispensed.

8. A container for holding and/or dispensing substance(s) comprising:
an outer cavity;
one or more inner chambers, disposed within the outer cavity, for holding the substance(s); and
means for enabling the substance in an inner chamber to be dispensed out of the outer cavity by moving the container wherein such inner chamber moves with respect to the outer chamber and into a dispensing position.

9. The container of claim 8 wherein the movement of the container to enable the substance to be dispensed is linear.

10. The container of claim 8 wherein the movement of the container to enable the substance to be dispensed is lifting.

11. The container of claim 8 wherein the container can be moved with one hand to enable the substance to be dispensed.

12. The container of claim 8 wherein the means for dispensing the substance includes:
a grip coupled to an inner chamber and extending through the outer cavity wherein, when the grip is moved, such inner chamber moves with respect to the outer chamber into the dispensing position.

13. The container of claim 12 wherein the outer cavity has one or more openings there through and wherein the grip includes:
one or more ends extending through such openings and coupled to an inner chamber, and
wherein the openings in the outer cavity are sufficiently large with respect to the grip ends to allow the grip to be moved such that the inner chamber and the outer cavity can be moved with respect to each other into the dispensing position.

14. The container of claim 8 wherein the means for dispensing a substance includes:
a spout coupled to the outer cavity; and
a spout connector coupling an inner chamber to the spout; and
wherein, when the container is moved, the spout connector engages the spout such that the substance held in the inner chamber can be dispensed through the spout connector and out of the spout.

15. The container of claim 8 further including a lid, removably coupled to an inner chamber, for adding or removing a substance to such inner chamber.

16. A dispensing system for use in a container having a chamber for holding a substance, such dispensing system comprising:
a spout coupled to the container;
a spout connector coupling the chamber to the spout; and
wherein, when the container is moved, the spout connector engages the spout such that the substance held in the chamber can be dispensed through the spout connector and out of the spout.

17. The dispensing system of claim 16 wherein the movement of the container for the spout connector to engage the spout to enable the substance to be dispensed is linear.

18. The dispensing system of claim 16 wherein the movement of the container for the spout connector to engage the spout to enable the substance to be dispensed is lifting.

19. The dispensing system of claim 16 wherein the container can be moved with one hand for the spout connector to engage the spout to enable the substance to be dispensed.

20. The dispensing system of claim 16 further comprising:
a channel within the spout in which the end of the spout connector coupling the spout is movably disposed; and
wherein, when the container is moved, such spout connector end moves within the channel to a dispensing position for the substance in the chamber.
